(19) United States
(12) Patent Application Publication
(10) Pub. No.: US 2005/0058403 A1
(43) Pub. Date: Mar. 17, 2005

(54) Body assembly of light receiving/transmission module

(76) Inventor: Chen-Hung Hung, Chia-Yi Hsien (TW)

Correspondence Address: Troxell Law Office PLLC, Suite 1404, 5205 Leesburg Pike, Falls Church, VA, 22041, US

(21) Appl. No.: 10/663,665

(22) Filed: Sep. 17, 2003

(51) Int. Cl. G02B 6/36

(52) U.S. Cl. 385/78

(57) ABSTRACT

A body assembly of light receiving/transmission module is disclosed. The body assembly comprises a sleeve and a coupling including an upper part, a lower part, a hole through the upper and the lower parts, and a bundle of optical fibers fitted in the hole. Aligning light in an optical connector of an alignment device inserted in the sleeve with the bundle of optical fibers will align the sleeve with the coupling prior to being formed together. The invention can substantially eliminate a potential misalignment of the sleeve with the coupling and significantly increase the performance.

### BACKGROUND OF THE INVENTION

1. Field of the Invention

The present invention relates to optical connectors and more particularly to an improved body assembly of light receiving/transmission module.

2. Description of Related Art

Laser diodes are used as a light source in the current optical communication system. The cross-sectional view of a well known light receiving/transmission module is shown in FIG. 1 A laser diode is encapsulated to form a laser diode element B. The laser diode element B has its head fastened in the hollow part of a lower portion of a cylindrical base C. This forms a light transmission section A. A body assembly D is mounted on top of the base C. The body assembly D comprises a hollow, cylindrical member E, a ring F coaxially fitted in a lower part of the cylindrical member E, a hollow cylinder G formed of ceramic materials being coaxially fitted in the cylindrical member E, and a cylindrical element H fitted in the cylinder G. Also, a bottom of the cylindrical element H is ground to form a slope I which is adapted to prevent reflected light from directly impinging on a laser diode element B. Otherwise, the laser diode element B may be interfered by noise. A flexible bundle of plastic optical fibers I is disposed through a longitudinal axis of the cylindrical element H. As such, light emitted from the laser diode element B is focused on the core of the bundle of optical fibers I. The focused light is then directed to the core of the bundle of optical fibers of an optical connector (not shown). The base C, the cylindrical member E, the ring F, the ceramic cylinder G, and the cylindrical element H are fastened together by means of rivets. Further, a light transmission assembly is formed by encapsulating the light transmission section A and the body assembly D together.

Likewise, a light receiving assembly is formed by encapsulating the light transmission section A and the body assembly D together if the laser diode element B is implemented as a detection element. Either the light transmission assembly or the light receiving assembly is adapted to couple to an optical connector by plugging. However, the prior light receiving/transmission module suffered from several disadvantages. For example, the assembly is difficult and the manufacturing cost is relatively high due to many constituent components. The rivet fastening may accumulate allowances of respective components to an extent of adversely affecting the quality of light transmission. It is bulky, thus contradicting the trend of slimness, compactness, and lightweight of such products. While the ceramic cylinder G is advantageous for being adapted to precise machining and the optical connector is highly wear-resistant for withstanding many times of plugging and unplugging, the manufacturing cost is relatively high because equipment is expensive and the manufacturing processes are tedious. Hence, a need for improvement exists.

### SUMMARY OF THE INVENTION

It is an object of the present invention to provide a body assembly of light receiving/transmission module, comprising a sleeve comprising a bore; and a coupling comprising an upper part, a lower part, a hole through the upper and the lower parts, and a bundle of optical fibers fitted in the hole, whereby aligning light in an optical connector of an alignment device inserted in the bore with the bundle of optical fibers will align the sleeve with the coupling prior to being formed together. By utilizing the present invention, a number of advantages such as substantially elimination of a potential misalignment of the optical connector with the bundle of optical fibers in the coupling, minimum light transmission loss, significant increase of the total performance, reduced number of components, simple and quick assembly, low manufacturing cost, elimination of tedious manufacturing processes, high precision, compactness, and wide applications can be obtained.

The above and other objects, features and advantages of the present invention will become apparent from the following detailed description taken with the accompanying drawings.

### BRIEF DESCRIPTION OF THE DRAWINGS

FIG. 1 is a cross-sectional view of a conventional light receiving/transmission module;

FIG. 2 is a cross-sectional view of a light receiving/transmission module according to the invention;

FIG. 3 is a partially cut-away perspective view of the light receiving/transmission module shown in FIG. 2;

FIG. 4 is a cross-sectional view of the sleeve shown in FIG. 2;

FIG. 5 is a cross-sectional view of the coupling shown in FIG. 2; and

FIG. 6 is a cross-sectional view of the light receiving/transmission module shown in FIG. 2, where an alignment device is used for aligning the sleeve and the coupling prior to assembly.

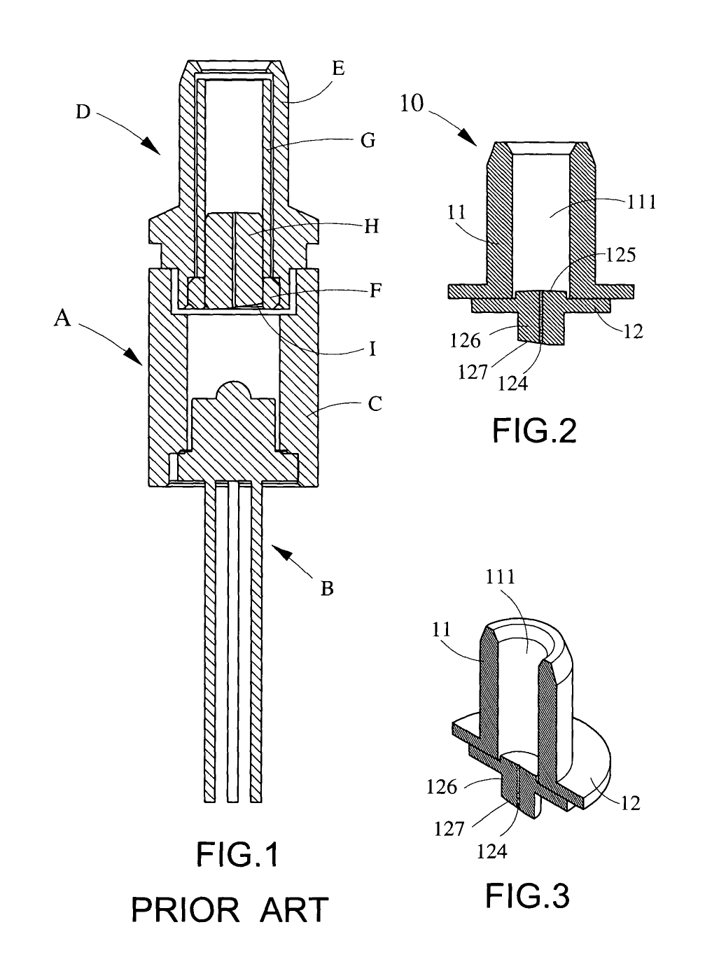

### DETAILED DESCRIPTION OF THE PREFERRED EMBODIMENTS

Referring to FIGS. 2 and 3, there is shown a body assembly 10 of light receiving/transmission module constructed in accordance with the invention. The body assembly 10 comprises a sleeve 11 and a coupling 12. The coupling 12 will be aligned with the sleeve 11 by an alignment device prior to being formed together.

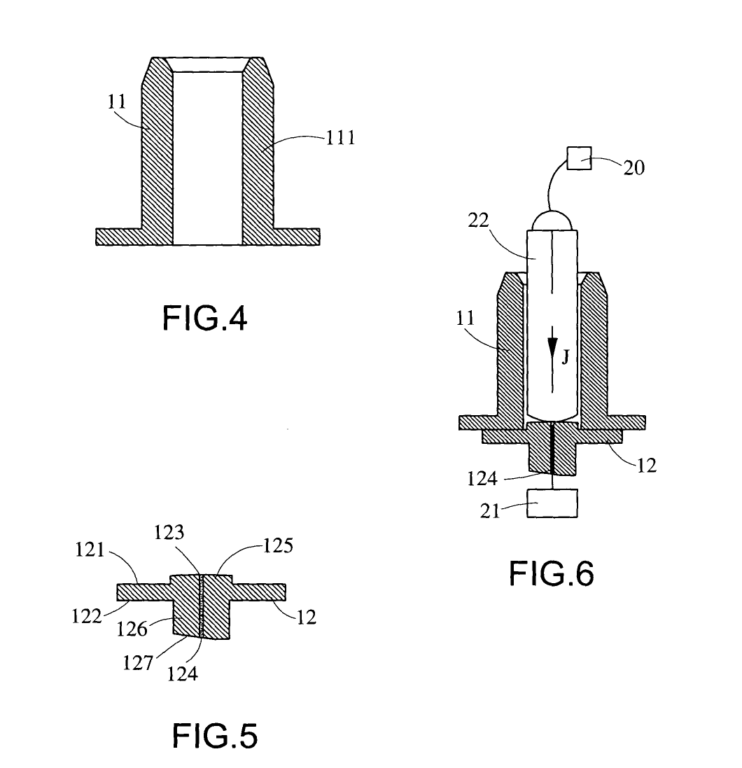

Referring to FIG. 4, the sleeve 11 comprises a bore 111 for receiving an optical connector (not shown) for light transmission. Referring to FIG. 5, the coupling 12 comprises an upper part 121, a lower part 122, and a hole 123 through both the upper part 121 and the lower part 122. A bundle of optical fibers 124 is fitted in the hole 123. A convex projection 125 is formed on top of the upper part 121. The projection 125 is received in the bore 111 to be in contact with a convex projection at the bottom of the optical connector inserted in the bore 111. The projection 125 is adapted to eliminate a possible gap between the upper part 121 and the optical connector. The lower part 122 comprises a lower cylindrical element 126 having a bottom slope 127 for preventing reflected light from directly impinging on a laser diode Otherwise, the laser diode may be interfered by noise.

Referring to FIG. 6, an alignment device is shown. The alignment device comprises a distal light source 20 and a light receiver 21 below the coupling 12. An optical connector 22 is coupled to the light source 20 and is inserted in the bore 111. Light emitted from the light source 20 is directed to the optical connector 22 as indicated by arrow J. The alignment of the sleeve 11 with the coupling 12 can be obtained by aligning the light J with the bundle of optical fibers 124 as sensed by the light receiver 21. Once aligned, the sleeve 11 and the coupling 12 can be formed together thereafter. Accordingly, the total performance can be increased significantly.

The body assembly 10 can be coupled to a light receiving/transmission section to form a light receiving/transmission module. The light receiving/transmission module is then molded in a plastic mold. The produced light receiving/transmission module is adapted to allow the optical connector to insert in the bore 111. As such, light emitted from the light source 20 is focused on the core of the bundle of optical fibers 124 in the coupling 12. The focused light is then directed to the core of the bundle of optical fibers of the optical connector.

In brief, the sleeve 11 and the coupling 12 are aligned prior to being formed together. As such, a potential misalignment of the bundle of optical fibers of the optical connector with the bundle of optical fibers 124 in the coupling 12 can be decreased to a minimum. Further, light transmission loss is decreased to a minimum, resulting in a significant increase of the total performance. Moreover, the body assembly 10 of the invention includes the following advantages. Reduced number of components, simple and quick assembly, low manufacturing cost, elimination of tedious manufacturing processes, high precision, compactness, and wide applications.

While the invention herein disclosed has been described by means of specific embodiments, numerous modifications and variations could be made thereto by those skilled in the art without departing from the scope and spirit of the invention set forth in the claims.

1. A body assembly of light receiving/transmission module, comprising:
a sleeve comprising a bore; and
a coupling comprising an upper part, a lower part, a hole through the upper and the lower parts, and a bundle of optical fibers fitted in the hole,
whereby aligning light in an optical connector of an alignment device inserted in the bore with the bundle of optical fibers will align the sleeve with the coupling prior to being formed together.

2. The body assembly of claim 1, wherein the upper part of the coupling comprises a top projection received in the bore.

3. The body assembly of claim 1, wherein the lower part of the coupling comprises a bottom slope.
